(19) United States
(12) Patent Application Publication
(10) Pub. No.: US 2021/0241300 A1
(43) Pub. Date: Aug. 5, 2021

(54) Pricing Operations Utilizing a Uniform Abstract Sales Transaction Model

(71) Applicant: salesforce.com, inc., San Francisco, CA (US)

(72) Inventors: Parth Vijay Vaishnav, Newark, CA (US); Mitchell Christensen, Livermore, CA (US)

(21) Appl. No.: 16/779,378

(22) Filed: Jan. 31, 2020

(51) Int. Cl. G06Q 30/02; G06Q 30/06

(52) U.S. Cl. CPC G06Q 30/0206; G06Q 30/0603; G06Q 30/0635

(57) ABSTRACT

Embodiments regard pricing operations utilizing a uniform abstract sales transaction model. An embodiment of one or more storage mediums include instructions for receiving a pricing request for pricing of one or more sales items, the pricing request including a sales transaction, the sales transaction being a data structure that includes an input parameter, the input parameter including input data; directing the sales transaction to a pricing engine for the sales operation; performing pricing for each sales item of one or more sales items based on the sales transaction to generate a pricing output; generating an output parameter utilizing the input parameter, and inserting the pricing output into the output parameter; and generating a pricing response including the sales transaction with the output parameter, the sales transaction data structure being unchanged by the pricing engine.

### TECHNICAL FIELD

Embodiments relate to techniques for computer operations. More particularly, embodiments relate to pricing operations utilizing a uniform abstract sales transaction model.

### BACKGROUND

In providing support for client operations in a pricing architecture, the architecture is intended to provide efficient and effective pricing operations for clients without requiring the support of an internal pricing structure.

However, representations and contents of sales transactions in conventional operations are dependent on the particular implementation, and do not provide any uniform content or structure. As a result, there is no uniform structure for handling sales transactions in different operations such as price calculation, price auditing, and other operations.

This lack of consistency in sales transactions causes inefficiencies in processing as sales transactions are transferred, and causes additional overhead when any system changes are made affecting sales transactions.

### BRIEF DESCRIPTION OF THE DRAWINGS

Embodiments are illustrated by way of example, and not by way of limitation, in the figures of the accompanying drawings in which like reference numerals refer to similar elements.

FIG. 1 is an illustration of a computing platform including processing of pricing requests for sales transactions, according to some embodiments;

FIG. 2 is an illustration of a sales transaction for pricing operations, according to some embodiments;

FIG. 3 is an illustration of processing of a pricing request including a sales transaction, according to some embodiments;

FIG. 4 is flow chart to illustrate a pricing operation for a sales transaction, according to some embodiments;

FIG. 5 illustrates a block diagram of an environment in which a pricing service may be provided according to some embodiments; and

FIG. 6 illustrates further details of an environment in which an on-demand database service may be provided.

### DETAILED DESCRIPTION

In the following description, numerous specific details are set forth. However, embodiments may be practiced without these specific details. In other instances, well-known circuits, structures and techniques have not been shown in detail in order not to obscure the understanding of this description.

In some embodiments, an apparatus, system, or process is to provide for processing of sales transactions as a uniform abstract model in pricing engine operations.

As used herein, a sales transaction refers to a high-level abstract interface that is object agnostic and can apply to multiple different concrete implementations. In some embodiments, the sales transaction:

(1) Provides a uniform data model for pricing that acts as a prototype or template for any of multiple different types of objects across a computing platform, which may be across different business units, and which may include custom objects as well as standard objects.

(2) Allows for easily mapping and transforming from one object type to another and providing an inherent platform defined field mapping.

(3) Provides an implementation agnostic API object that acts as a first class API object that is returned from a pricing engine as part of the output.

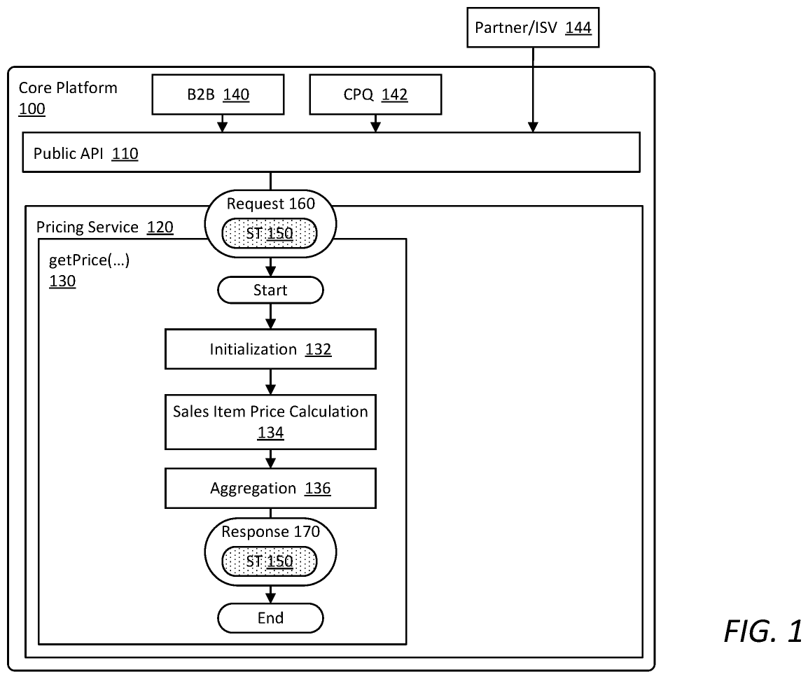

FIG. 1 is an illustration of a computing platform including processing of pricing requests for sales transactions, according to some embodiments. As illustrated, a core computing platform 100 may provide multiple services including, but not limited to, a pricing service 120 to provide pricing operations for multiple different types of sales operations. The core platform 100 may include numerous other operations and functions.

The core platform 100 may include a public application program interface (API) 110 for connection of multiple different types of clients that may generate operation requests, including requests to the pricing service 120. The requests may include business to business (B2B) requests 140 and configure-price-quote (CPQ) requests 142 provided within the core platform 100, and partner or independent software vendor (ISV) requests 144 received from outside the core platform 100.

The pricing service 120 in particular includes a getPrice function 130 to determine pricing for one or more sales items in a sales transaction, the sales items being any combination of goods and services. In a basic operation, the getPrice function for a particular request includes initialization of the pricing operation 132, sales price calculation for each sales item of the request 134, which may include the application of a particular pricing plan for the sales item, and aggregation of the pricing calculations to generate a pricing output 136, which may then be provided to the requesting client.

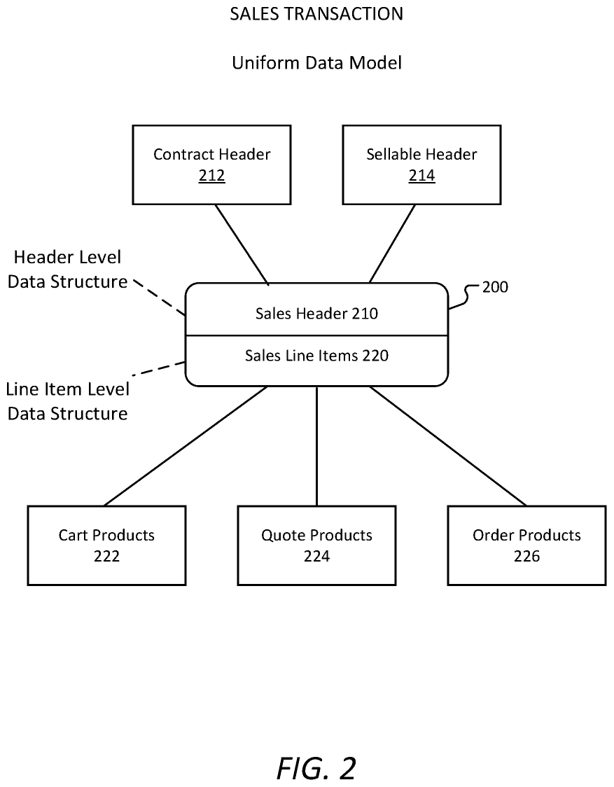

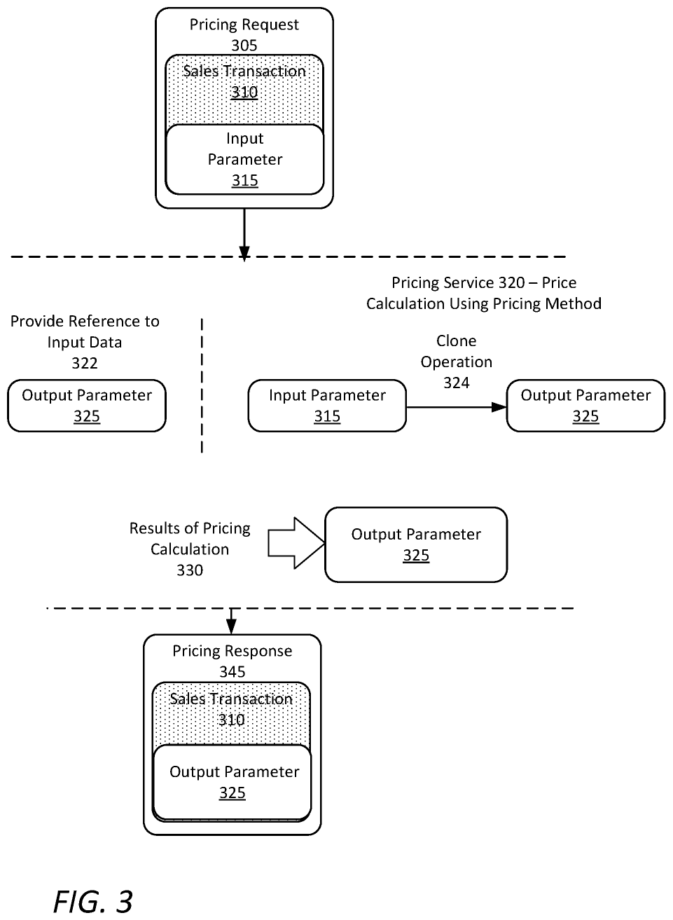

In some embodiments, the pricing service 120 receives a pricing request 160 from the client, the pricing request 160 including a sales transaction 150. The client is to provide the sales transaction (consisting of a sales header and a set of sales items) in the pricing request 160, such a sales transaction further illustrated in FIG. 2. The pricing service produces a pricing response 170, the pricing response including the sales transaction 150. In some embodiments, the pricing engine 120 does not update the sales transaction 150 in the database as a result of price calculations, the pricing service instead generating an output parameter while maintaining the input data of the sales transaction. The generation of output parameter may include providing reference to the input data, or cloning an input parameter of the sales transaction to generate the output parameter for the pricing results. Further details regarding the processing of the sales request 160 and sales transaction 150 to generate the sales response 170 are provided in FIG. 3.

In some embodiments, the platform 100 allows for mapping and transforming of a sales transaction 150 from one object type to another, the platform 100 to provide an inherent platform defined field mapping for the sales transaction. The sales transaction 150 acts a prototype for all objects in the platform 100, and represents an implementation agnostic API object. In operation, a uniform sales transaction 150 may be used in Cart Products to represent transactions for a buyer experience; Quote Items to represent transactions for a seller experience; Order Products for provisioning and changing orders; and Contract Headers to track services over time, make changes, and provide renewal. The sales transaction provides an abstract interface that may then be utilized in multiple operations, the interface including a uniform data model.

FIG. 2 is an illustration of a sales transaction for pricing operations, according to some embodiments. A sales transaction 200 provides a uniform data model for use in pricing operations. In some embodiments, the sales transaction 200 includes a sales header 210 and a set of sales line items 220 to represent the information used for a business to transact the sale of goods and services, with the sales header 210 and sales line items 220 being broken down into separate interfaces. In some embodiments, the sales transaction is maintained in processing by a pricing service, thus providing a data model that is available in any operation. In some embodiments, the sales transaction 2001 further includes an input or output parameter for pricing operations, as further illustrated in FIG. 3.

The sales header 210 represents a header level data structure used in both a request and a response representing a particular sale operation, such as, for example, a Quote, a Cart, or an Order. As illustrated, the sales header may include, but are not limited to:

(a) Contract Header 212 (for contract line items)—A contract header may be utilized for tracking contract services over time, and making changes and renewing as required.

(b) Sellable Header 214 (for sellable line item)—A sellable header represents a generic header used by a platform API as an interface to use for external platform use cases. A sellable header may be used as a custom object for a customer's business process.

The sales line items 220 represent a line item level data structure in both a request and a response representing each sales items and quality for the sale operation. The sales line items may include, but are line limited to:

(a) Cart Products 222 (representing cart line items—CartLineltem)—Cart products may be used primarily to represent transactions based on a buyer experience, i.e., the items in a sales cart for a prospective purchase.

(b) Quote Products 224 (representing quote line items—QuoteLine)—Quote products may be used primarily to represent transactions based on a seller experience, i.e., to provide a quote for certain goods and services.

(c) Order Products 226 (representing order line items—OrderProduct)—Order products may be used by operations and fulfillment to provision and change orders.

It is noted that a pricing request may be connected to additional constructs that affect the transaction, including, for example:

(a) Price Adjustment Item—A construct to describe and define any positive or negative adjustments to the price to be applied at either the header level or for individual line items. The adjustment may be viewed as a discount, with a negative discount indicating that the customer incurrs a charge and a positive discount indicating the customer receives a rebate.

(b) Tax Item—A construct that stores taxation based information. A price adjustment could also incur taxes so tax line items are related to individual line items or individual adjustments, which are in turn related to line items or the sales header (via an adjustment group).

FIG. 3 is an illustration of processing of a pricing request including a sales transaction, according to some embodiments. In some embodiments, a pricing request 305, such as pricing request 160 illustrated in FIG. 1, includes a sales transaction 310 in provides a uniform data model for use in pricing operations. In some embodiments, the sales transaction 310 includes a sales header and a set of sales line items, as illustrated in FIG. 2, and an input parameter 315 representing the pricing request.

In some embodiments, the pricing request 305 is directed to a pricing service in a computing platform for price calculation according to a particular pricing method 320 according to the data indicated by the sales header and sales line items, In some embodiments, the input parameter is immutable by the pricing service 320 in generating pricing of the sales transaction. In some embodiments, the pricing service is to generate an output parameter 325 for pricing results utilizing the input parameter. In some embodiments, the generation of the output parameter may include, but is not limited to, one or more of the following:

(a) The pricing service is to utilize reference to the input data in the input parameter 322 for the generation of the output parameter 325 for pricing results;

(b) The pricing service 320 is to clone 324 the input parameter 315 of the sales transaction 310 to generate the output parameter 325. The input and output parameters thus are separate objects, and the input parameter is unchanged.

The pricing service is then to insert the pricing results 330 resulting from the pricing operation into the output parameter 325, and to a generate a pricing response 345 including the sales transaction 310 including the output parameter 325. In this manner the pricing service 320 maintains the sales transaction 310 in the output, which includes the sales header 210 and sales line items 220 as illustrated in FIG. 2.

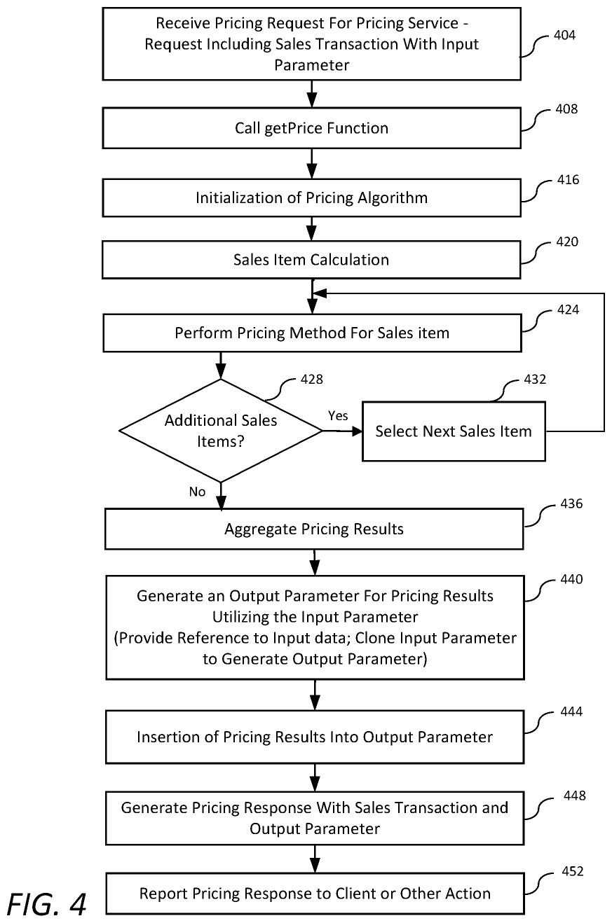

FIG. 4 is flow chart to illustrate a pricing operation for a sales transaction, according to some embodiments. In some embodiments, a pricing request is received for a pricing service in a computing platform 404, wherein the pricing request includes a sales transaction with input parameter, such as illustrated in FIGS. 2 and 3, with the pricing request requesting pricing for set of one or more sales items. In response to the pricing request, pricing function (getPrice) is called 408 and a pricing algorithm is initialized 416.

The sale item calculation 420 then proceeds with performing a pricing method for a particular sales item 424, wherein the pricing method may be different for each of the one or more sales items. A determination may be made whether there are any additional sales items for calculation 428, and, if so, a next sales item of the set of one or more sales items is selected 432 and the respective pricing method is performed for the next sales item 424.

Upon completion of pricing operations for each of the one or more sales items, the pricing results for the sales transaction are aggregated 436. In some embodiments, an output parameter is generated for pricing results utilizing the input parameter 440. The generation of the output parameter may include, but is not limited to, providing reference to the input data in the input parameter for the generation of the output parameter; or the input parameter of the sales transaction may be cloned to generate the output parameter. The aggregated pricing results are inserted into the generated output parameter 444. A pricing response is generated including the sales transaction with the output parameter containing the pricing results 448, and the pricing results are reported to the client or other action is taken with regard to the completed pricing response 452.

The examples illustrating the use of technology disclosed herein should not be taken as limiting or preferred. The examples are intended to sufficiently illustrate the technology disclosed without being overly complicated and are not intended to illustrate all of the technologies disclosed. A person having ordinary skill in the art will appreciate that there are many potential applications for one or more implementations of this disclosure and hence, the implementations disclosed herein are not intended to limit this disclosure in any fashion.

One or more implementations may be implemented in numerous ways, including as a process, an apparatus, a system, a device, a method, a computer readable medium such as a computer readable storage medium containing computer readable instructions or computer program code, or as a computer program product comprising a computer usable medium having a computer readable program code embodied therein.

Other implementations may include a non-transitory computer readable storage medium storing instructions executable by a processor to perform a method as described above. Yet another implementation may include a system including memory and one or more processors operable to execute instructions, stored in the memory, to perform a method as described above.

Implementations may include:

In some embodiments, one or more non-transitory computer-readable storage mediums having stored thereon executable computer program instructions that, when executed by one or more processors, cause the one or more processors to perform operations including receiving a pricing request for pricing of a set of one or more sales items, the pricing request including a sales transaction, the sales transaction being a data structure that includes an input parameter, the input parameter including input data; directing the pricing request to a pricing engine for pricing of the one or more sales items; performing pricing for each sales item of the set of one or more sales items based on the sales transaction to generate a pricing output; generating an output parameter utilizing the input parameter, and inserting the pricing output into the output parameter; and generating a pricing response, the pricing response including the sales transaction with the output parameter, wherein the sales transaction data structure is unchanged by the pricing engine.

In some embodiments, a system includes one or more processors; a memory to store data including data for pricing; and a computing platform including a pricing service to perform pricing operations, wherein the pricing service is to receive a pricing request for a pricing of a set of one or more sales items, the pricing request including a sales transaction, the sales transaction being a data structure that includes an input parameter, the input parameter including input data, perform pricing for each sales item of the set of one or more sales items based on the sales transaction to generate a pricing output, generate an output parameter utilizing the input parameter, and inserting the pricing output into the output parameter, and generate a pricing response, the pricing response including the sales transaction with the output parameter, wherein the sales transaction data structure is unchanged by the pricing engine.

In some embodiments, a method includes receiving a request for a pricing operation for a set of one or more sales items from a client, the pricing request including a sales transaction, the sales transaction being a data structure that includes at least a sales header data structure, a sales line item data structure including the one or more sales items, and an input parameter, the input parameter including input data; directing the sales transaction to a pricing engine for performance of the sales operation; performing pricing for each sales item of the set of one or more sales items based on the sales transaction to generate a pricing output; generating an output parameter utilizing the input parameter, and inserting the pricing output into the output parameter; and generating a pricing response, the pricing response including the sales transaction with the output parameter, wherein the sales transaction data structure is unchanged by the pricing engine.

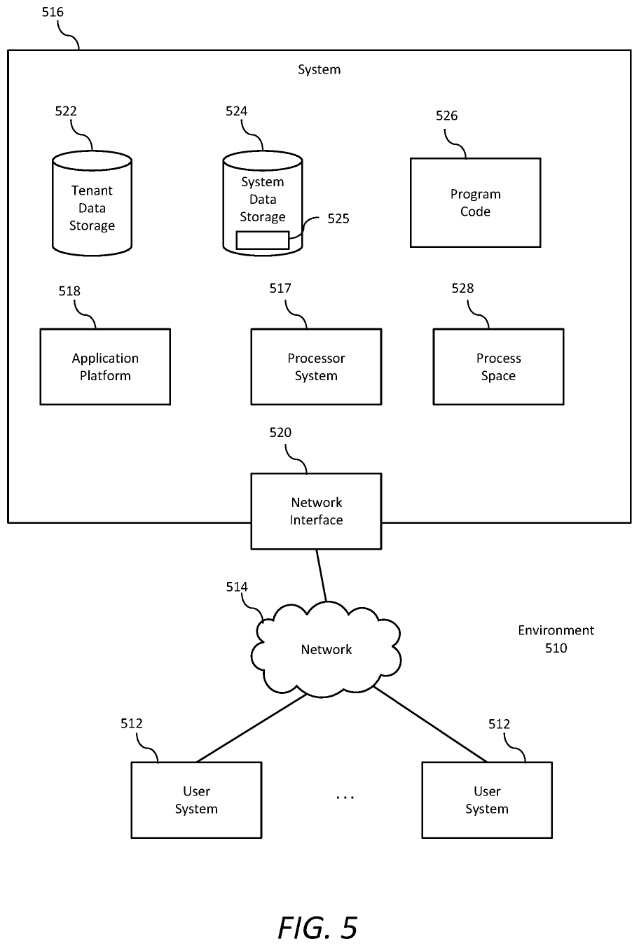

FIG. 5 illustrates a block diagram of an environment in which a pricing service may be provided according to some embodiments. In some embodiments, the environment 510 includes support for a pricing service to provide pricing for a sales transaction, such as a sales transaction illustrated in FIGS. 1-3. The environment 510 may include user systems 512, network 514, system 516, processor system 517, application platform 518, network interface 520, tenant data storage 522, system data storage 524, program code 526, and process space 528. In other embodiments, environment 510 may not have all of the components listed and/or may have other elements instead of, or in addition to, those listed above.

Environment 510 is an environment in which an on-demand database service exists. User system 512 may be any machine or system that is used by a user to access a database user system. For example, any of user systems 512 can be a handheld computing device, a smart phone, a laptop or tablet computer, a work station, and/or a network of computing devices. As illustrated in herein FIG. 5 and in more detail in FIG. 5, user systems 512 may interact via a network 514 with an on-demand database service, such as system 516.

An on-demand database service, such as system 516, is a database system that is made available to outside users that do not need to necessarily be concerned with building and/or maintaining the database system, but instead may be available for their use when the users need the database system (e.g., on the demand of the users). Some on-demand database services may store information from one or more tenants stored into tables of a common database image to form a multi-tenant database system (MTS). Accordingly, “on-demand database service 516” and “system 516” may be used interchangeably herein. A database image may include one or more database objects. A relational database management system (RDMS) or the equivalent may execute storage and retrieval of information against the database object(s). Application platform 518 may be a framework that allows the applications of system 516 to run, such as the hardware and/or software, e.g., the operating system. In an embodiment, on-demand database service 516 may include an application platform 518 that enables creation, managing and executing one or more applications developed by the provider of the on-demand database service, users accessing the on-demand database service via user systems 512, or third-party application developers accessing the on-demand database service via user systems 512.

The users of user systems 512 may differ in their respective capacities, and the capacity of a particular user system 512 might be entirely determined by permissions (permission levels) for the current user. For example, where a salesperson is using a particular user system 512 to interact with system 516, that user system has the capacities allotted to that salesperson. However, while an administrator is using that user system to interact with system 516, that user system has the capacities allotted to that administrator. In systems with a hierarchical role model, users at one permission level may have access to applications, data, and database information accessible by a lower permission level user, but may not have access to certain applications, database information, and data accessible by a user at a higher permission level. Thus, different users will have different capabilities with regard to accessing and modifying application and database information, depending on a user's security or permission level.

Network 514 is any network or combination of networks of devices that communicate with one another. For example, network 514 can be any one or any combination of a LAN (local area network), WAN (wide area network), telephone network, wireless network, point-to-point network, star network, token ring network, hub network, or other appropriate configuration. As the most common type of computer network in current use is a TCP/IP (Transfer Control Protocol and Internet Protocol) network, such as the global internetwork of networks often referred to as the “Internet” with a capital “I,” that network will be used in many of the examples herein. However, it should be understood that the networks that one or more implementations might use are not so limited, although TCP/IP is a frequently implemented protocol.

User systems 512 might communicate with system 516 using TCP/IP and, at a higher network level, use other common Internet protocols to communicate, such as HTTP, FTP, AFS, WAP, etc. In an example where HTTP is used, user system 512 might include an HTTP client commonly referred to as a “browser” for sending and receiving HTTP messages to and from an HTTP server at system 516. Such an HTTP server might be implemented as the sole network interface between system 516 and network 514, but other techniques might be used as well or instead. In some implementations, the interface between system 516 and network 514 includes load sharing functionality, such as round-robin HTTP request distributors to balance loads and distribute incoming HTTP requests evenly over a plurality of servers. At least as for the users that are accessing that server, each of the plurality of servers has access to the MTS' data; however, other alternative configurations may be used instead.

In one embodiment, system 516, shown in FIG. 5, implements a web-based customer relationship management (CRM) system. For example, in one embodiment, system 516 includes application servers configured to implement and execute CRM software applications as well as provide related data, code, forms, webpages and other information to and from user systems 512 and to store to, and retrieve from, a database system related data, objects, and Webpage content. With a multi-tenant system, data for multiple tenants may be stored in the same physical database object, however, tenant data typically is arranged so that data of one tenant is kept logically separate from that of other tenants so that one tenant does not have access to another tenant's data, unless such data is expressly shared. In certain embodiments, system 516 implements applications other than, or in addition to, a CRM application. For example, system 516 may provide tenant access to multiple hosted (standard and custom) applications, including a CRM application. User (or third-party developer) applications, which may or may not include CRM, may be supported by the application platform 518, which manages creation, storage of the applications into one or more database objects and executing of the applications in a virtual machine in the process space of the system 516.

One arrangement for elements of system 516 is shown in FIG. 5, including a network interface 520, application platform 518, tenant data storage 522 for tenant data 523, system data storage 524 for system data 525 accessible to system 516 and possibly multiple tenants, program code 526 for implementing various functions of system 516, and a process space 528 for executing MTS system processes and tenant-specific processes, such as running applications as part of an application hosting service. Additional processes that may execute on system 516 include database indexing processes.

Several elements in the system shown in FIG. 5 include conventional, well-known elements that are explained only briefly here. For example, each user system 512 could include a desktop personal computer, workstation, laptop or tablet computer, smart phone, or any wireless access protocol (WAP) enabled device or any other computing device capable of interfacing directly or indirectly to the Internet or other network connection. User system 512 typically runs an HTTP client, e.g., a browsing program (also referred to as a web browser or browser), such as Edge or Internet Explorer from Microsoft, Safari from Apple, Chrome from Google, Firefox from Mozilla, or a WAP-enabled browser in the case of a smart phone or other wireless device, or the like, allowing a user (e.g., subscriber of the multi-tenant database system) of user system 512 to access, process and view information, pages and applications available to it from system 516 over network 514. Each user system 512 also typically includes one or more user interface devices, such as a keyboard, a mouse, touch pad, touch screen, pen, voice interface, gesture recognition interface, or the like, for interacting with a graphical user interface (GUI) provided by the browser on a display (e.g., a monitor screen, LCD display, etc.) in conjunction with pages, forms, applications and other information provided by system 516 or other systems or servers. For example, the user interface device can be used to access data and applications hosted by system 516, and to perform searches on stored data, and otherwise allow a user to interact with various GUI pages that may be presented to a user. As discussed above, embodiments are suitable for use with the Internet, which refers to a specific global internetwork of networks. However, it should be understood that other networks can be used instead of the Internet, such as an intranet, an extranet, a virtual private network (VPN), a non-TCP/IP based network, any LAN or WAN or the like.

According to one embodiment, each user system 512 and all of its components are operator configurable using applications, such as a browser, including computer code run using a central processing unit such as an Intel Core series processor or the like. Similarly, system 516 (and additional instances of an MTS, where more than one is present) and all of their components might be operator configurable using application(s) including computer code to run using a central processing unit such as processor system 517, which may include an Intel Core series processor or the like, and/or multiple processor units. A computer program product embodiment includes a machine-readable storage medium (media) having instructions stored thereon/in which can be used to program a computer to perform any of the processes of the embodiments described herein. Computer code for operating and configuring system 516 to intercommunicate and to process webpages, applications and other data and media content as described herein are preferably downloaded and stored on a hard disk or solid state drive (SSD), but the entire program code, or portions thereof, may also be stored in any other volatile or non-volatile memory medium or device as is well known, such as a ROM or RAM, or provided on any media capable of storing program code, such as any type of rotating media including floppy disks, optical discs, digital versatile disk (DVD), compact disk (CD), microdrive, and magneto-optical disks, and magnetic or optical cards, nanosystems (including molecular memory ICs), or any type of media or device suitable for storing instructions and/or data. Additionally, the entire program code, or portions thereof, may be transmitted and downloaded from a software source over a transmission medium, e.g., over the Internet, or from another server, as is well known, or transmitted over any other conventional network connection as is well known (e.g., extranet, VPN, LAN, etc.) using any communication medium and protocols (e.g., TCP/IP, HTTP, HTTPS, Ethernet, etc.) as are well known. It will also be appreciated that computer code for implementing embodiments can be implemented in any programming language that can be executed on a client system and/or server or server system such as, for example, C, C++, HTML, any other markup language, Java™ JavaScript, ActiveX, any other scripting language, such as VBScript, and many other programming languages as are well known may be used. (Java™ is a trademark of Sun Microsystems, Inc.).

According to one embodiment, each system 516 is configured to provide webpages, forms, applications, data and media content to user (client) systems 512 to support the access by user systems 512 as tenants of system 516. As such, system 516 provides security mechanisms to keep each tenant's data separate unless the data is shared. If more than one MTS is used, they may be located in close proximity to one another (e.g., in a server farm located in a single building or campus), or they may be distributed at locations remote from one another (e.g., one or more servers located in city A and one or more servers located in city B). As used herein, each MTS could include one or more logically and/or physically connected servers distributed locally or across one or more geographic locations. Additionally, the term “server” is meant to include a computer system, including processing hardware and process space(s), and an associated storage system and database application (e.g., OODBMS or RDBMS) as is well known in the art. It should also be understood that “server system” and “server” are often used interchangeably herein. Similarly, the database object described herein can be implemented as single databases, a distributed database, a collection of distributed databases, a database with redundant online or offline backups or other redundancies, etc., and might include a distributed database or storage network and associated processing intelligence.

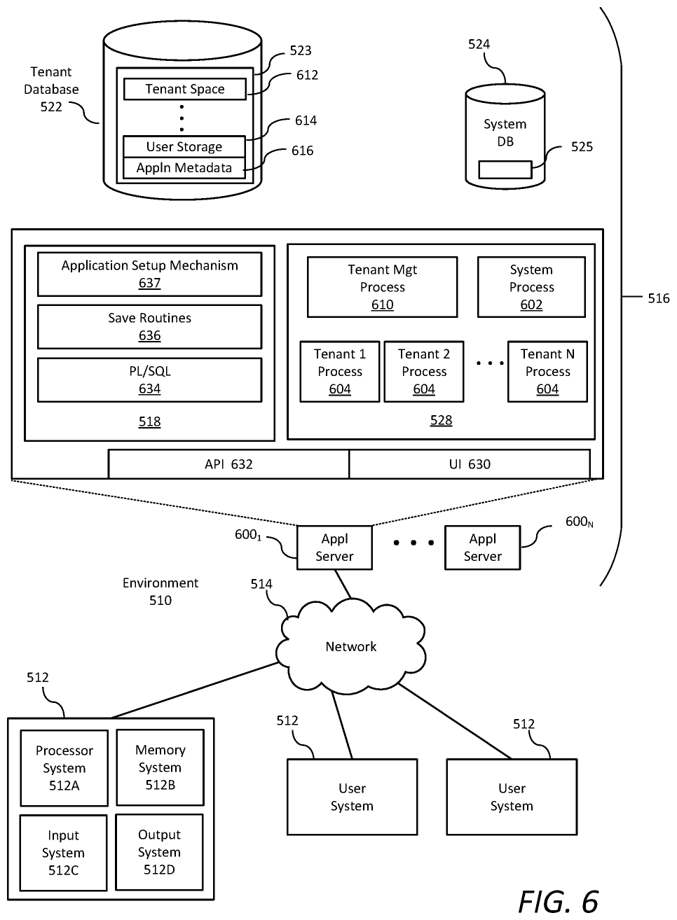

FIG. 6 illustrates further details of an environment in which an on-demand database service may be provided. FIG. 6 provides further detail regarding elements of system 516. In addition, various interconnections in an embodiment are provided. FIG. 6 shows that user system 512 may include processor system 512A, memory system 512B, input system 512C, and output system 512D. FIG. 6 shows network 514 and system 516. FIG. 6 also shows that system 516 may include tenant data storage 522, tenant data 523, system data storage 524, system data 525, User Interface (UI) 630, Application Program Interface (API) 632, PL/SOQL 634, save routines 636, application setup mechanism 638, applications servers 600₁-600_{N}, system process space 602, tenant process spaces 604, tenant management process space 610, tenant storage area 612, user storage 614, and application metadata 616. In other embodiments, environment 510 may not have the same elements as those listed above and/or may have other elements instead of, or in addition to, those listed above.

User system 512, network 514, system 516, tenant data storage 522, and system data storage 524 were discussed above in FIG. 5. Regarding user system 512, processor system 512A may be any combination of one or more processors. Memory system 512B may be any combination of one or more memory devices, short term, and/or long-term memory. Input system 512C may be any combination of input devices, such as one or more keyboards, mice, trackballs, scanners, cameras, and/or interfaces to networks. Output system 512D may be any combination of output devices, such as one or more monitors, printers, and/or interfaces to networks. As shown by FIG. 6, system 516 may include a network interface 520 (of FIG. 5) implemented as a set of HTTP application servers 600, an application platform 518, tenant data storage 522, and system data storage 524. Also shown is system process space 602, including individual tenant process spaces 604 and a tenant management process space 610. Each application server 600 may be configured to tenant data storage 522 and the tenant data 523 therein, and system data storage 524 and the system data 525 therein to serve requests of user systems 512. The tenant data 523 might be divided into individual tenant storage areas 612, which can be either a physical arrangement and/or a logical arrangement of data. Within each tenant storage area 612, user storage 614 and application metadata 616 might be similarly allocated for each user. For example, a copy of a user's most recently used (MRU) items might be stored to user storage 614. Similarly, a copy of MRU items for an entire organization that is a tenant might be stored to tenant storage area 612. A UI 630 provides a user interface and an API 632 provides an application programmer interface to system 516 resident processes to users and/or developers at user systems 512. The tenant data and the system data may be stored in various databases, such as one or more Oracle™ databases.

Application platform 518 includes an application setup mechanism 638 that supports application developers' creation and management of applications, which may be saved as metadata into tenant data storage 522 by save routines 636 for execution by subscribers as one or more tenant process spaces 604 managed by tenant management process 610 for example. Invocations to such applications may be coded using PL/SOQL 634 that provides a programming language style interface extension to API 632. A detailed description of some PL/SOQL language embodiments is discussed in commonly owned U.S. Pat. No. 7,730,478 entitled, “Method and System for Allowing Access to Developed Applicants via a Multi-Tenant Database On-Demand Database Service”, issued Jun. 1, 2010 to Craig Weissman, which is incorporated in its entirety herein for all purposes. Invocations to applications may be detected by one or more system processes, which manage retrieving application metadata 616 for the subscriber making the invocation and executing the metadata as an application in a virtual machine.

Each application server 600 may be communicably coupled to database systems, e.g., having access to system data 525 and tenant data 523, via a different network connection. For example, one application server 600₁ might be coupled via the network 514 (e.g., the Internet), another application server 600_{N-1} might be coupled via a direct network link, and another application server 600_{N} might be coupled by yet a different network connection. Transfer Control Protocol and Internet Protocol (TCP/IP) are typical protocols for communicating between application servers 600 and the database system. However, it will be apparent to one skilled in the art that other transport protocols may be used to optimize the system depending on the network interconnect used.

In certain embodiments, each application server 600 is configured to handle requests for any user associated with any organization that is a tenant. Because it is desirable to be able to add and remove application servers from the server pool at any time for any reason, there is preferably no server affinity for a user and/or organization to a specific application server 600. In one embodiment, therefore, an interface system implementing a load balancing function (e.g., an F5 BIG-IP load balancer) is communicably coupled between the application servers 600 and the user systems 512 to distribute requests to the application servers 600. In one embodiment, the load balancer uses a least connections algorithm to route user requests to the application servers 600. Other examples of load balancing algorithms, such as round robin and observed response time, also can be used. For example, in certain embodiments, three consecutive requests from the same user could hit three different application servers 600, and three requests from different users could hit the same application server 600. In this manner, system 516 is multi-tenant, wherein system 516 handles storage of, and access to, different objects, data and applications across disparate users and organizations.

As an example of storage, one tenant might be a company that employs a sales force where each salesperson uses system 516 to manage their sales process. Thus, a user might maintain contact data, leads data, customer follow-up data, performance data, goals and progress data, etc., all applicable to that user's personal sales process (e.g., in tenant data storage 522). In an example of an MTS arrangement, since all of the data and the applications to access, view, modify, report, transmit, calculate, etc., can be maintained and accessed by a user system having nothing more than network access, the user can manage his or her sales efforts and cycles from any of many different user systems. For example, if a salesperson is visiting a customer and the customer has Internet access in their lobby, the salesperson can obtain critical updates as to that customer while waiting for the customer to arrive in the lobby.

While each user's data might be separate from other users' data regardless of the employers of each user, some data might be organization-wide data shared or accessible by a plurality of users or all of the users for a given organization that is a tenant. Thus, there might be some data structures managed by system 516 that are allocated at the tenant level while other data structures might be managed at the user level. Because an MTS might support multiple tenants including possible competitors, the MTS should have security protocols that keep data, applications, and application use separate. Also, because many tenants may opt for access to an MTS rather than maintain their own system, redundancy, up-time, and backup are additional functions that may be implemented in the MTS. In addition to user-specific data and tenant specific data, system 516 might also maintain system level data usable by multiple tenants or other data. Such system level data might include industry reports, news, postings, and the like that are sharable among tenants.

In certain embodiments, user systems 512 (which may be client systems) communicate with application servers 600 to request and update system-level and tenant-level data from system 516 that may require sending one or more queries to tenant data storage 522 and/or system data storage 524. System 516 (e.g., an application server 600 in system 516) automatically generates one or more SQL statements (e.g., one or more SQL queries) that are designed to access the desired information. System data storage 524 may generate query plans to access the requested data from the database.

Each database can generally be viewed as a collection of objects, such as a set of logical tables, containing data fitted into predefined categories. A “table” is one representation of a data object and may be used herein to simplify the conceptual description of objects and custom objects. It should be understood that “table” and “object” may be used interchangeably herein. Each table generally contains one or more data categories logically arranged as columns or fields in a viewable schema. Each row or record of a table contains an instance of data for each category defined by the fields. For example, a CRM database may include a table that describes a customer with fields for basic contact information such as name, address, phone number, fax number, etc. Another table might describe a purchase order, including fields for information such as customer, product, sale price, date, etc. In some multi-tenant database systems, standard entity tables might be provided for use by all tenants. For CRM database applications, such standard entities might include tables for Account, Contact, Lead, and Opportunity data, each containing pre-defined fields. It should be understood that the word “entity” may also be used interchangeably herein with “object” and “table”.

In some multi-tenant database systems, tenants may be allowed to create and store custom objects, or they may be allowed to customize standard entities or objects, for example by creating custom fields for standard objects, including custom index fields. U.S. patent application Ser. No. 10/817,161, filed Apr. 2, 2004, with U.S. Pat. No. 7,779,039, entitled “Custom Entities and Fields in a Multi-Tenant Database System”, and which is hereby incorporated herein by reference, teaches systems and methods for creating custom objects as well as customizing standard objects in a multi-tenant database system. In certain embodiments, for example, all custom entity data rows are stored in a single multi-tenant physical table, which may contain multiple logical tables per organization. It is transparent to customers that their multiple “tables” are in fact stored in one large table or that their data may be stored in the same table as the data of other customers.

Embodiments may be provided, for example, as a computer program product which may include one or more machine-readable media (including a non-transitory machine-readable or computer-readable storage medium) having stored thereon machine-executable instructions that, when executed by one or more machines such as a computer, network of computers, or other electronic devices, may result in the one or more machines carrying out operations in accordance with embodiments described herein. A machine-readable medium may include, but is not limited to, floppy diskettes, optical disks, CD-ROMs (Compact Disc-Read Only Memories), and magneto-optical disks, ROMs, RAMs, EPROMs (Erasable Programmable Read Only Memories), EEPROMs (Electrically Erasable Programmable Read Only Memories), magnetic tape, magnetic or optical cards, flash memory, or other type of media/machine-readable medium suitable for storing machine-executable instructions.

Moreover, embodiments may be downloaded as a computer program product, wherein the program may be transferred from a remote computer (e.g., a server) to a requesting computer (e.g., a client) by way of one or more data signals embodied in and/or modulated by a carrier wave or other propagation medium via a communication link (e.g., a modem and/or network connection).

It is to be noted that terms like “node”, “computing node”, “server”, “server device”, “cloud computer”, “cloud server”, “cloud server computer”, “machine”, “host machine”, “device”, “computing device”, “computer”, “computing system”, and the like, may be used interchangeably throughout this document. It is to be further noted that terms like “application”, “software application”, “program”, “software program”, “package”, “software package”, and the like, may be used interchangeably throughout this document. Also, terms like “job”, “input”, “request”, “message”, and the like, may be used interchangeably throughout this document.

Reference in the specification to “one embodiment” or “an embodiment” means that a particular feature, structure, or characteristic described in connection with the embodiment is included in at least one embodiment. The appearances of the phrase “in one embodiment” in various places in the specification are not necessarily all referring to the same embodiment.

While concepts been described in terms of several embodiments, those skilled in the art will recognize that embodiments not limited to the embodiments described but can be practiced with modification and alteration within the spirit and scope of the appended claims. The description is thus to be regarded as illustrative instead of limiting.

What is claimed is:

1. One or more non-transitory computer-readable storage mediums having stored thereon executable computer program instructions that, when executed by one or more processors, cause the one or more processors to perform operations comprising:
receiving a pricing request for pricing of a set of one or more sales items, the pricing request including a sales transaction, the sales transaction being a data structure that includes an input parameter, the input parameter including input data;
directing the pricing request to a pricing engine for pricing of the one or more sales items;
performing pricing for each sales item of the set of one or more sales items based on the sales transaction to generate a pricing output;
generating an output parameter utilizing the input parameter, and inserting the pricing output into the output parameter; and
generating a pricing response, the pricing response including the sales transaction with the output parameter, wherein the sales transaction data structure is unchanged by the pricing engine.

2. The one or more storage mediums of claim 1, wherein the sales transaction includes at least a sales header data structure and a sales line item data structure, the sales line item data structure including the one or more sales items for the pricing request.

3. The one or more storage mediums of claim 2, wherein the sales header data structure includes information describing the requested pricing.

4. The one or more storage mediums of claim 3, wherein sales header data structure identifies the pricing operation as one of:
a quote for the one or more sales items;
a sales cart containing the one or more sales items; or
an order for the one or more sales items.

5. The one or more storage mediums of claim 3, wherein the sales header data structure is one of:
a contract header to track contract services; or
a sellable header to provide an interface for external platform use.

6. The one or more storage mediums of claim 2, wherein the sales line item data structure includes a line item for each of the one or more sales item, the line item for a first sales item including at least an identification of the first sales item and a quantity of the first sales item for pricing.

7. The one or more storage mediums of claim 6, wherein the sales line item data structure includes one of:
cart products to representing sales cart line items;
quote products to representing quote line items; or
order products to represent order line items.

8. The one or more storage mediums of claim 1, wherein generating the output parameter includes one or more of:
providing reference to the input data in the input parameter for the generation of the output parameter; or
cloning the input parameter to generate the output parameter.

9. The one or more storage mediums of claim 1, wherein the executable computer program instructions further include instructions for:
returning the pricing response with the sales transaction including the output parameter to a requesting client.

10. A system comprising:
one or more processors;
a memory to store data, including data for pricing operations; and
a computing platform including a pricing service to perform pricing operations, wherein the pricing service is to:
receive a pricing request for pricing of a set of one or more sales items, the pricing request including a sales transaction, the sales transaction being a data structure that includes an input parameter, the input parameter including input data,
perform pricing for each sales item of the set of one or more sales items based on the sales transaction to generate a pricing output,
generate an output parameter utilizing the input parameter, and inserting the pricing output into the output parameter, and
generate a pricing response, the pricing response including the sales transaction with the output parameter, wherein the sales transaction data structure is unchanged by the pricing service.

11. The system of claim 10, wherein the sales transaction includes at least a sales header data structure and a sales line item data structure, the sales line item data structure including the one or more sales items for the pricing request.

12. The system of claim 11, wherein the sales header data structure includes information describing the requested pricing.

13. The system of claim 12, wherein the sales header data structure identifies the pricing operation as one of:
a quote for the one or more sales items;
a sales cart containing the one or more sales items; or
an order for the one or more sales items.

14. The system of claim 12, wherein the sales header data structure is one of:
a contract header to track contract services; or
a sellable header to provide an interface for external platform use.

15. The system of claim 11, wherein the sales line item data structure includes a line item for each of the one or more sales item, the line item for a first sales item including at least an identification of the first sales item and a quantity of the first sales item for pricing.

16. The system of claim 15, wherein the sales line item data structure includes one of:
cart products to representing sales cart line items;
quote products to representing quote line items; or
order products to represent order line items.

17. The system of claim 10, wherein generating the output parameter includes one or more of:
providing reference to the input data in the input parameter for the generation of the output parameter; or
cloning the input parameter to generate the output parameter.

18. The system of claim 10, wherein the sales transaction is a uniform abstract structure that may be utilized in multiple different types of objects in the computing platform.

19. A method comprising:
receiving a pricing request for pricing of a set of one or more sales items from a client, the pricing request including a sales transaction, the sales transaction being a data structure that includes at least a sales header data structure, a sales line item data structure including the one or more sales items, and an input parameter, the input parameter including input data;
directing the sales transaction to a pricing engine for pricing of the one or more sales items;
performing pricing for each sales item of the set of one or more sales items based on the sales transaction to generate a pricing output;
generating an output parameter utilizing the input parameter, and inserting the pricing output into the output parameter; and
generating a pricing response, the pricing response including the sales transaction with the output parameter, wherein the sales transaction data structure is unchanged by the pricing engine.

20. The method of claim 19, wherein the sales header data structure includes information describing the requested pricing.

21. The method of claim 19, wherein the sales line item data structure includes a line item for each of the one or more sales item, the line item for a first sales item including at least an identification of the first sales item and a quantity of the first sales item for pricing.

22. The method of claim 19, wherein the input parameter of the sales transaction is immutable by the pricing engine.

23. The method of claim 19, further comprising transforming the sales transaction from a first type of object to a second type of object in processing.
